(19) United States
(12) Patent Application Publication
(10) Pub. No.: US 2012/0331041 A1
(43) Pub. Date: Dec. 27, 2012

(54) LOOKUP TABLE LOGIC APPARATUS AND SERVER COMMUNICATING WITH THE SAME

(76) Inventors: Hyun-sung Shin, Seoul (KR); In-Su Choi, Gyeonggi-do (KR)

(21) Appl. No.: 13/432,383

(22) Filed: Mar. 28, 2012

(30) Foreign Application Priority Data
Jun. 27, 2011 (KR) 10-2011-0062225

(51) Int. Cl. G06F 15/16

(52) U.S. Cl. 709/203

(57) ABSTRACT

An LUT logic apparatus for handling tasks requested by a plurality of clients via a server in a network in which the server is connected with the plurality of clients may include a plurality of table identification (ID) processors, a controller, and a media access control (MAC) processor. The plurality of table ID processors correspond respectively to a plurality of table IDs. When an on signal is received, the table ID processors read response data corresponding to requested tasks from a storage unit and generate and output packets including the read response data. The controller identifies table IDs corresponding to the requested tasks and outputs the on signal to the corresponding table ID processors. The MAC processor parses the tasks requested by the server, transfers the parsed tasks to the controller, and outputs the packets output from the table ID processors corresponding to the parsed tasks to the clients.

### CROSS-REFERENCE TO RELATED APPLICATION

This application claims priority under 35 U.S.C. §119 to Korean Patent Application No. 10-2011-0062225 filed on Jun. 27, 2011, in the Korean Intellectual Property Office (KIPO), the entire contents of which are incorporated herein by reference.

### BACKGROUND

1. Field

Example embodiments relate to a lookup table (LUT) logic apparatus and a server communicating with the same, and more particularly, to an LUT logic apparatus performing an operation corresponding to a request from a server in a network in which the server is connected with a plurality of clients, and a server communicating with the LUT logic apparatus.

2. Description of Related Art

In a general server system, a central processing unit (CPU) of a server processes entire request packets of all clients received via a network, and thereby a heavy load is put on the CPU. Since the CPU processes all continuous packet responses, such as streaming, and also separately processes the same request packets simultaneously received from a plurality of clients, too much load may be put on the CPU. In this case, the overload of the CPU causes delay of a network response, resulting in performance deterioration of the entire server system.

### SUMMARY

concept least one example embodiment provide a lookup table (LUT) logic apparatus that defines processing of a request packet frequently received by a server in an LUT in advance, and then separately processes the request packet received thereafter.

Example embodiments also provide a server that defines processing of a frequently received request packet in an LUT in advance, and then processes the request packet received thereafter.

The technical objectives of example embodiments are not limited to the above disclosure; other objectives may become apparent to those of ordinary skill in the art based on the following descriptions.

In accordance with an at least one example embodiment, an LUT logic apparatus performs tasks requested by a plurality of clients via a server in a network in which the server is connected with the plurality of clients, and includes a plurality of table identification (ID) processors, a controller, and a media access control (MAC) processor. The plurality of table ID processors are prepared according to a plurality of table IDs. When an on signal is received, the table ID processors read response data to the requested tasks from a storage and generate and output packets consisting of the read response data. The controller identifies table IDs corresponding to the requested tasks and outputs the on signal to the corresponding table ID processors. The MAC processor parses the tasks requested by the server, transfers the parsed tasks to the controller, and outputs the packets output from the corresponding table ID processors to the clients.

In some embodiments, each of the table ID processors may include registers respectively configured to store a starting address and ending address of the corresponding piece of the response data in the storage, and a data size of the corresponding packet among the packets.

In some embodiments, each of the table ID processors may further include a counter configured to count the response data from the starting address to the ending address by the data size and output a count signal, and the controller may read the response data according to the count signals.

In some embodiments, each of the table ID processors may include a client address register configured to store a client address received from the server.

In some embodiments, each of the table ID processors may further include a packet generator configured to generate a packet consisting of a corresponding client address and the corresponding piece of the read response data.

In some embodiments, the storage may be a network storage connected to the network.

In some embodiments, each of the table ID processors may include a storage address register configured to store a network storage address, and the controller may access the network storage using the storage address and read the corresponding piece of the response data.

In accordance with another example embodiment, a server performs a task requested by a client in a network in which the server is connected with a plurality of clients, and includes a determiner and a processor. The determiner determines whether the task requested by the client is a predefined task, and outputs the corresponding ID and a client address to an LUT logic apparatus when the requested task is a predefined task. The processor processes the requested task when the requested task is not a predefined task.

In some embodiments, when the determiner determines that the requested task is not a predefined task but is to be newly defined, the processor may give an ID to the requested task, generate and store response data corresponding to the task in a storage, and store storage information on the response data stored in the storage in the LUT logic apparatus.

In some embodiments, the storage may be a network storage connected to the network.

In some embodiments, the processor may store a network storage address in the LUT logic apparatus.

### BRIEF DESCRIPTION OF THE DRAWINGS

The above and other features and advantages of example embodiments will become more apparent by describing in detail example embodiments with reference to the attached drawings. The accompanying drawings are intended to depict example embodiments and should not be interpreted to limit the intended scope of the claims. The accompanying drawings are not to be considered as drawn to scale unless explicitly noted.

FIG. 1 is a block diagram of a network according to at least one example embodiment;

FIG. 2 shows the signal flow between a client, server, and lookup table (LUT) logic;

FIG. 3A illustrates a table identification (ID) setting process between a server and an LUT logic having a local memory;

FIG. 3B illustrates a table ID setting process among a server, an LUT logic, and a network storage;

FIG. 4A illustrates a process in which an LUT logic having a local memory processes a request packet requested by a server;

FIG. 4B illustrates a process in which an LUT logic accesses a network memory and processes a request packet requested by a server;

FIG. 5 shows registers of an LUT logic;

FIG. 6 shows values stored in an LUT logic; and

FIG. 7 is a detailed block diagram of an LUT logic.

### DETAILED DESCRIPTION OF THE EMBODIMENTS

Detailed example embodiments are disclosed herein. However, specific structural and functional details disclosed herein are merely representative for purposes of describing example embodiments. Example embodiments may, however, be embodied in many alternate forms and should not be construed as limited to only the embodiments set forth herein.

Accordingly, while example embodiments are capable of various modifications and alternative forms, embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example embodiments. As used herein, the term “and/or” includes any and all combinations of one or more of the associated listed items.

It will be understood that when an element is referred to as being “connected” or “coupled” to another element, it may be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (e.g., “between” versus “directly between”, “adjacent” versus “directly adjacent”, etc.).

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

It should also be noted that in some alternative implementations, the functions/acts noted may occur out of the order noted in the figures. For example, two figures shown in succession may in fact be executed substantially concurrently or may sometimes be executed in the reverse order, depending upon the functionality/acts involved.

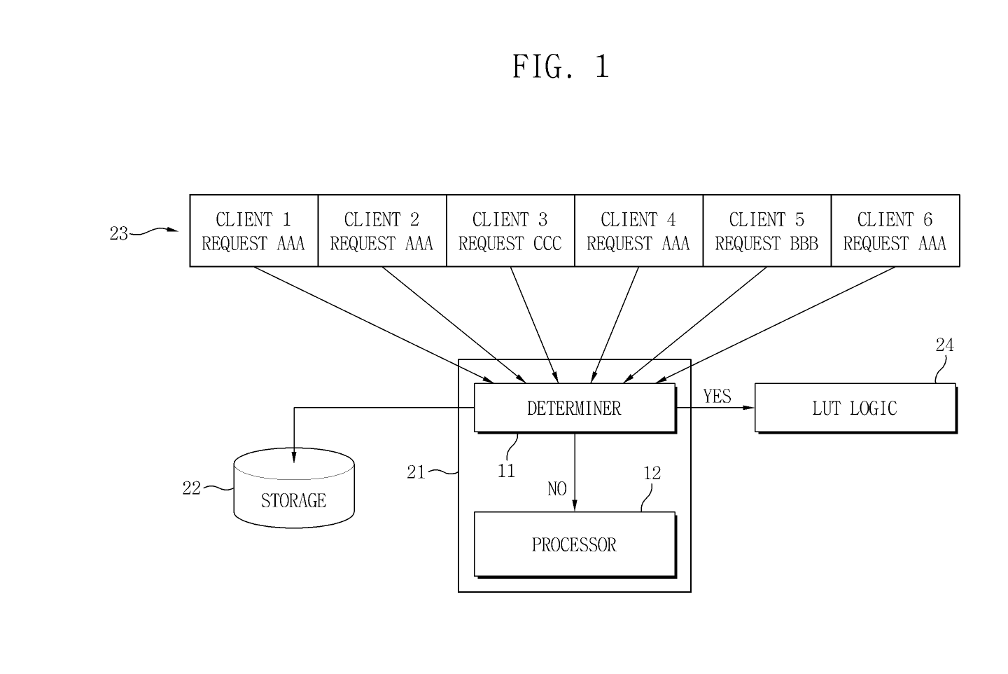

FIG. 1 is a block diagram of a network according to at least one example embodiment. The illustrated network includes a server 21, a storage unit 22, a plurality of clients 23, and a lookup table (LUT) logic 4. The server 21 includes a determiner 11 and a processor 12. The processor 12 may be, for example, a central processing unit (CPU).

The determiner 11 determines a request frequently received from the plurality of clients 23 in advance, gives a table identification (ID) to the request, and stores the request in the storage unit 22 by storing the table ID of the request in the storage unit 22. Determination of how frequently a request should be received before being stored in the storage unit 22 may be based on a user's preference and/or experience.

Assuming that requests are received from clients 1 to 6 in sequence as shown in FIG. 1, when request AAA of client 2 is received after request AAA of client 1, the CPU 12 defines request AAA as a frequently received packet, inputs request AAA in the storage unit 22, and then informs the LUT logic 24 that request AAA is a frequently received packet.

When a request is received from a client, the determiner 11 determines whether the request has been stored in the storage unit 22. When the request has been stored in the storage unit 22, the determiner 11 causes the LUT logic 24 to process the request. On the other hand, when the request has not been stored in the storage unit 22, the determiner 11 causes the processor 12 to process the request.

For example, request CCC of client 3 is processed by the processor 12. Since request AAA of client 4 is a previously stored request packet, the determiner 11 turns on the LUT logic 24 and causes the LUT logic 24 to process request AAA of client 4, thereby reducing a load of the CPU 12.

Meanwhile, when the determiner 11 determines that a request has not been stored in the storage unit 22 but is frequently received, the processor 12 generates response data in response to the request. Subsequently, the processor 12 stores the generated response data in a memory connected to the LUT logic 24 or a network storage connected to a network, and stores storage information in the LUT logic 24. This will be described in detail later.

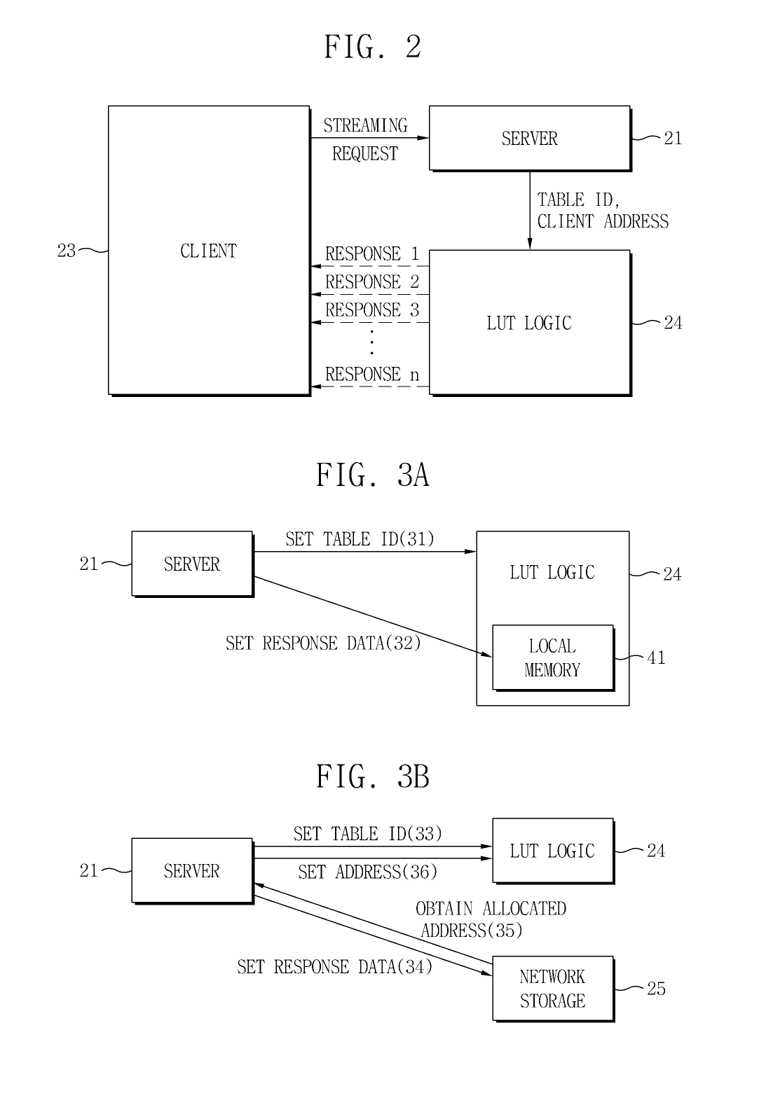

FIG. 2 shows the signal flow between a client, server, and LUT logic. Referring to FIG. 2, when a client 3 sends a streaming request to a server 21, the server 21 outputs a table ID of the request and a client address to an LUT logic 24. At this time, the server 21 has generated and stored in advance response data corresponding to the request to be processed by the LUT logic 24 in a local memory prepared in the LUT logic 24 or a network storage, and then has stored storage information, such as a starting address and ending address in the local memory or network storage and a size, in registers prepared in the LUT logic 24 through an input interface prepared in the LUT logic 24 or a network. Here, the network storage refers to a storage device connected to a network, including a network memory. The size is a data size to be read at one time, and also is a size of a data area of a packet to be generated later.

The LUT logic 24 processes the streaming request using the storage information and directly sends the response to the client 3.

FIG. 3A illustrates a table ID setting process between the server 21 and the LUT logic 24 having a local memory 41.

Referring to FIG. 3A, the server 21 sets a table ID in the LUT logic 24 according to the process described with reference to FIG. 1 (step 31), and sets and stores response data in the local memory 41 (step 32). Also, the server 21 may register a memory address of the response data in the local memory 41, etc. in a register also included in the LUT logic 24. The local memory 41 is prepared in the LUT logic 24.

FIG. 3B illustrates a table ID setting process among the server 21, the LUT logic 24, and the network storage 25.

Referring to FIG. 3B, the server 21 sets a table ID in the LUT logic 24 (step 33). Also, the server 21 sets response data corresponding to the table ID (step 34) and obtains an allocated address in the network storage 25 (step 35). Then, the server 21 sets a storage address in the LUT logic 24 (step 36).

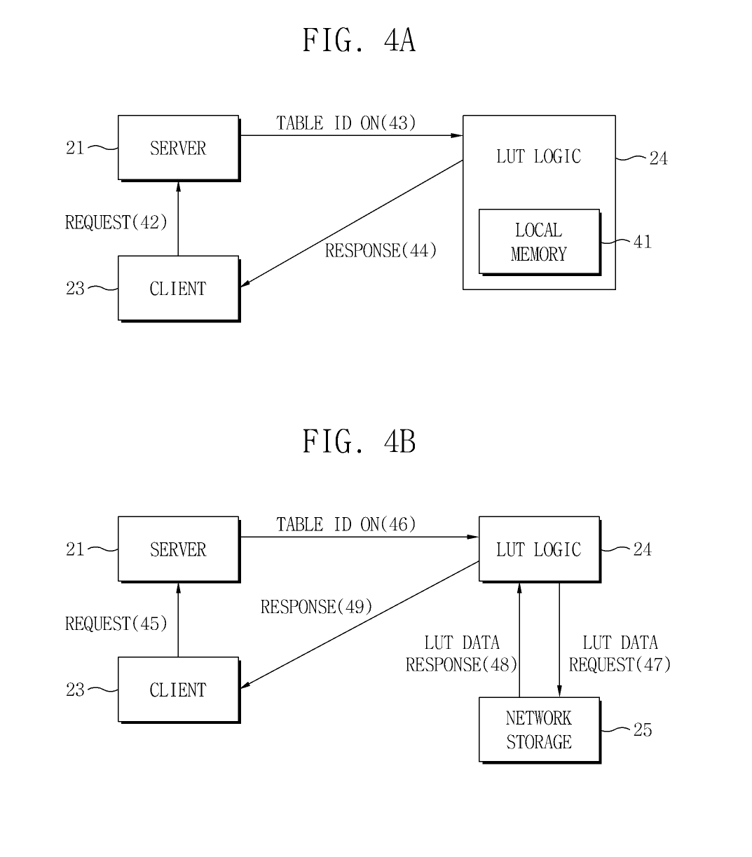

FIG. 4A illustrates a process in which an LUT logic 24 having a local memory 41 processes a request packet requested by the server 21.

When a client 3 sends a request packet to the server 21 (step 41), the server 21 sends a table ID on signal with a table ID of the request packet and a client address to the LUT logic 24 (step 43).

The LUT logic 24 reads data corresponding to the received table ID from the local memory 41 and outputs the read data to the client 3 using the received client address (step 44).

FIG. 4B illustrates a process in which an LUT logic 24 accesses a network storage 25 and processes a request packet requested by the server 21.

When the server 21 receives a request packet from a client 3 (step 45), the server 21 sends a table ID on signal with a table ID of the request packet and a client address to the LUT logic 24 (step 46).

The LUT logic 24 requests data corresponding to the received table ID from the network storage 25 (step 47), and receives a data response (step 48).

The LUT logic 24 outputs the data response to the client 3 using the received client address (step 49).

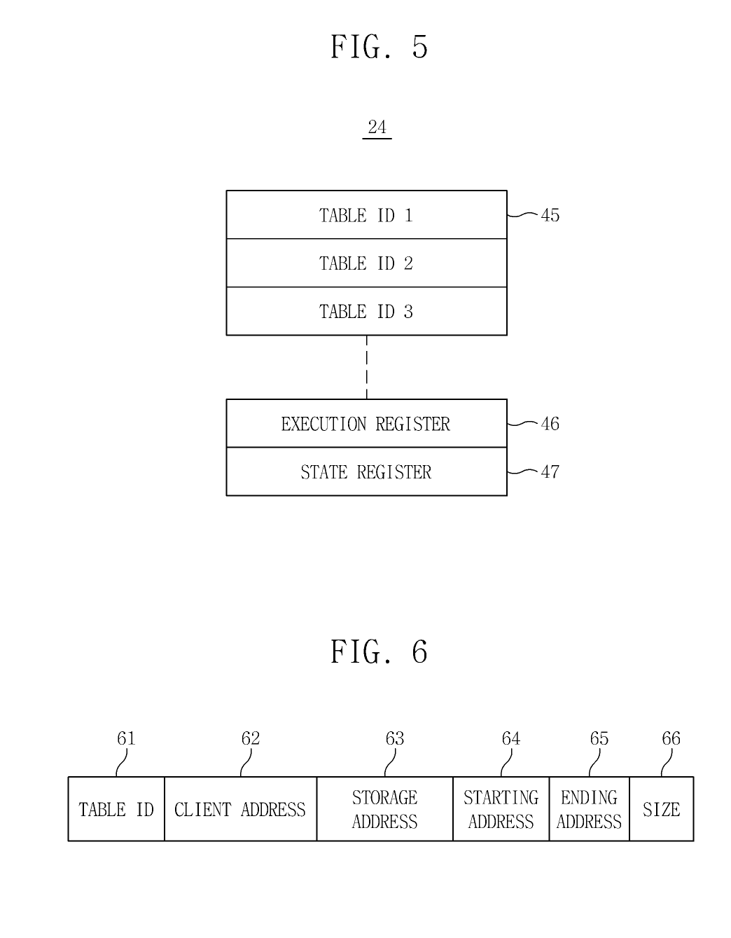

FIG. 5 shows registers of an LUT logic 24.

The LUT logic 24 includes N table ID blocks 45, an execution register 46, and a state register 47.

The table ID blocks 45 are registers for respective table IDs, and include starting addresses and ending addresses of data corresponding to tasks performed by the respective table IDs in a local memory 41 or a network storage 25.

To the execution register 46, information on an ID of a table to be executed and an address of a client that has requested the ID information are input.

To the state register 47, an ID of a hardware logic currently being executed by the table ID blocks 45 and a value indicating whether or not the hardware logic is executed are input. For example, as the value indicating whether or not the hardware logic is executed, “1” denotes a state in which the hardware logic is being executed, and “0” denotes an idle state in which a new table ID can be executed.

FIG. 6 shows values stored in an LUT logic 24.

The LUT logic 24 includes a table ID field 61, a client address field 62, a storage address field 63, a starting address field 64, an ending address field 65, and a size field 66.

The table ID field 61 stores an ID of an LUT, and the client address field 62 stores a client address to which a table ID block has transferred a response packet.

The storage address field 63 stores an address in a storage when the storage is not a local memory 41 but is connected to a network.

The starting address field 64 stores a starting address of response data to be read by each table ID block in a memory.

The ending address field 65 stores an ending address of response data to be read by each table ID block in a memory.

The size field 66 stores a size of a response packet.

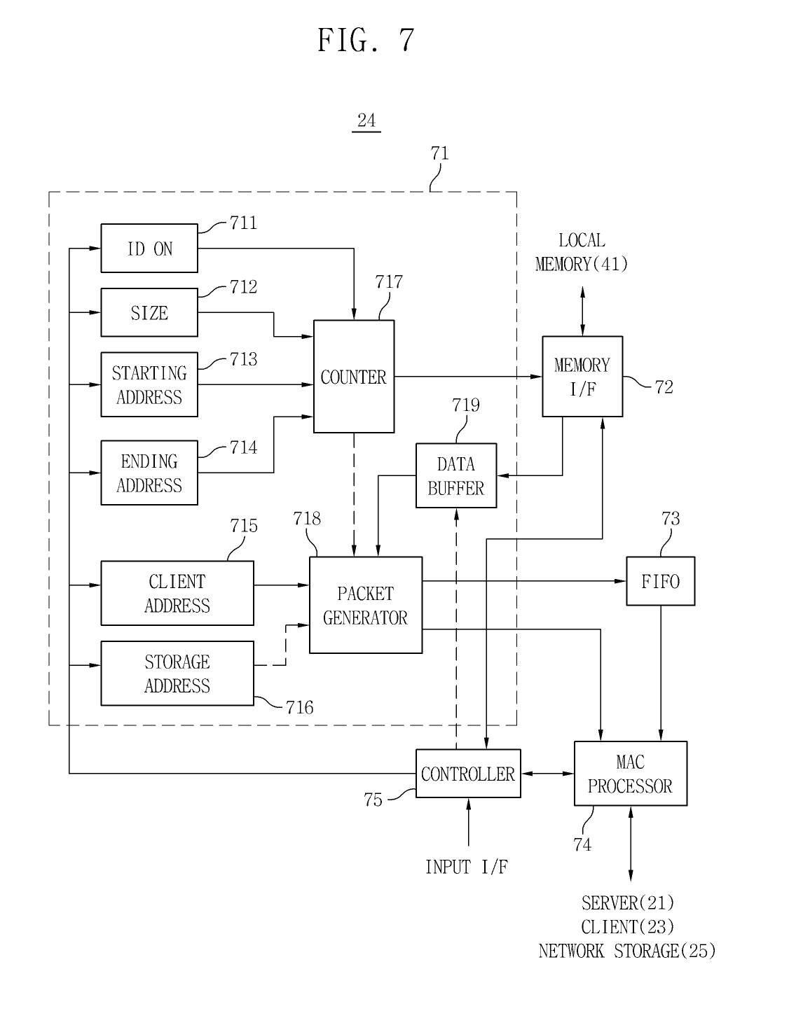

FIG. 7 is a detailed block diagram of an LUT logic 24.

The LUT logic 24 includes N table ID processors 71, a memory interface 72, a first-input first-output (FIFO) 73, a media access control (MAC) processor 74, and a controller 75. Also, the LUT logic 24 may further include a register unit including the execution register 46 and the state register 47 shown in FIG. 5. For the purpose of simplicity, only one of the N table ID processors 71 is illustrated in FIG. 7.

Each of the table ID processors 71 reads data stored in a local memory 41 through the memory interface 72 or data stored in a network storage 25 through a network in packet units, and generates Ethernet packets consisting of the data read in packet units. The FIFO 73 outputs the generated packets on a FIFO basis. While communicating with the server 21, the client 3 or the network storage 25 via the network, the MAC processor 74 parses a signal input from the network, outputs the parsed signal to the controller 75, and outputs a signal output from each of the table ID processors 71, the FIFO 73 or the controller 75 to the network.

Each of the table ID processors 71 includes an ID on register 711, a size register 712, a starting address register 713, an ending address register 714, and a client address register 715. When the network storage 25 is used, each of the table ID processors 71 may further include a storage address register 716. Also, each of the table ID processors 71 includes a counter 717, a packet generator 718, and a data buffer 719.

When the LUT logic 24 sets a table ID, the controller 75 registers a packet size, a starting address, and an ending address of response data transferred from the server 21 or input through an input interface in the corresponding registers 712, 713 and 714 of the corresponding table ID processor.

When the response data is stored in the network storage 25, an address in the network storage 25 is registered in the storage address register 716.

When the LUT logic 24 processes a request, the controller 75 outputs an on signal to the ID on register 711 of the corresponding table ID processor 71 using a table ID transferred from the server 21, and registers an address of a client to which a response needs to be transferred in the client address register 715.

The counter 717 counts the response data from the starting address to the ending address by the size and then outputs a count signal to the memory interface 72. The controller 75 reads data from the local memory 41 according to the count signal and temporarily stores the read data in the data buffer 719.

The packet generator 718 generates packets consisting of the data stored in the data buffer 719 and the client address, and sends the packets to the corresponding client 3 in sequence through the FIFO 73 and the MAC processor 74.

When the network storage 25 is used, a packet consisting of the count signal and the address registered in the storage address register 716 is generated by the packet generator 718 and output to the network storage 25 via the network. The controller 75 reads the corresponding data from the network storage 25 according to the count signal and temporarily stores the read data in the data buffer 719.

The packet generator 718 generates packets consisting of the data stored in the data buffer and the client address, and sends the packets to the corresponding client 3 in sequence through the FIFO 73 and the MAC processor 74.

An LUT logic apparatus according to at least one example embodiment can reduce a load put on a CPU of a server by distributing the load of the CPU using high-speed hardware logic.

The server in which the load of the CPU is reduced in this way can provide users with high quality service compared to conventional technology, and may result in development of new applications and software based on the high quality.

Example embodiments having thus been described, it will be obvious that the same may be varied in many ways. Such variations are not to be regarded as a departure from the intended spirit and scope of example embodiments, and all such modifications as would be obvious to one skilled in the art are intended to be included within the scope of the following claims.

What is claimed is:

1. A lookup table (LUT) logic apparatus for handling tasks requested by a plurality of clients via a server in a network in which the server is connected with the plurality of clients, the apparatus comprising:
a plurality of table identification (ID) processors corresponding, respectively, to a plurality of table IDs, and configured to read response data corresponding to the requested tasks from a storage unit and generate output packets including the read response data when an on signal is received;
a controller configured to identify table IDs corresponding to the requested tasks and output the on signal to the corresponding table ID processors; and
a media access control (MAC) processor configured to parse the tasks requested by the server, transfer the parsed tasks to the controller, and output the packets output from the table ID processors corresponding to the parsed tasks to the clients.

2. The LUT logic apparatus of claim 1, wherein each of the table ID processors includes registers respectively configured to store a starting address and ending address of a corresponding portion of the response data stored in the storage unit, and a data size of a packet corresponding to the portion of the response data.

3. The LUT logic apparatus of claim 2, wherein each of the table ID processors further includes a counter configured to count the response data from the starting address to the ending address according to the data size and output a count signal, and
the controller is configured to read the response data according to the count signals.

4. The LUT logic apparatus of claim 1, wherein each of the table ID processors includes a client address register configured to store a client address received from the server.

5. The LUT logic apparatus of claim 4, wherein each of the table ID processors further includes a packet generator configured to generate a packet consisting of a corresponding client address and a corresponding portion of the read response data.

6. The LUT logic apparatus of claim 1, wherein the storage unit is a network storage unit connected to the network.

7. The LUT logic apparatus of claim 6, wherein each of the table ID processors includes a storage address register configured to store a network storage address, and
the controller is configured to accesses the network storage by using the storage address and configured to read a corresponding portion of the response data.

8. A server performing a task requested by a client in a network in which the server is connected with a plurality of clients, the server comprising:
a determiner configured to determine whether the task requested by the client is a frequent request task, a frequent request task being a task that has been requested more than a reference number of times, and output a corresponding identification (ID) and a client address to a lookup table (LUT) logic apparatus when the requested task is a frequent request task; and
a processor configured to process the requested task when the requested task is not a frequent request task.

9. The server of claim 8, wherein, the processor is configured such that when the determiner determines that the requested task is a frequent request task for which an ID has not yet been assigned, the processor assigns an ID to the requested task, generates and stores response data corresponding to requested task in a storage unit, and stores storage information indicating the response data stored in the storage unit in the LUT logic apparatus.

10. The server of claim 9, wherein the storage unit is a network storage unit connected to the network.

11. The server of claim 10, wherein the processor is configured to store a network storage address in the LUT logic apparatus.

12. A system for handling a plurality of requests sent by one or more clients, the system comprising:
a look up table (LUT) logic configured to store response data corresponding to each of the plurality of requests; and
a server configured to receive requests from among the plurality of requests, the server including a processor and a determiner configured to determine a number of times a received request, from among the plurality of requests, has been received,
the determiner being configured to cause the LUT logic to handle the received request if the number of times the received request has been received exceeds a reference value, and configured to cause the processor to handle the received request if the number of times the received request has been received does not exceed the reference value.

13. The system, of claim 12, further comprising:
a storage unit, wherein, for each request from among the plurality of requests that has been received more than the reference number of times, the determiner is configured to store a corresponding table identification (ID) in the storage unit.

14. The system of claim 13, wherein the determiner is configured to cause the LUT logic to handle the received request by forwarding the table ID corresponding to the received request and a client address to the LUT logic if the number of times the received request has been received exceeds the reference value, the client address being an address of a client that sent the received request.

15. The system of claim 14, wherein the LUT logic is configured to handle the received request by retrieving the response data corresponding to the received request based on the table ID, and forwarding the retrieved response data to the client that sent the received request based on the client address.

16. The system of claim 12, wherein the LUT logic includes,
one or more table identification (ID) processors corresponding, respectively, to a plurality of table IDs, the one or more table ID processors each being configured to read response data corresponding to the plurality of requests from a storage unit and configured to generate output packets including the read response data in response to an on signal;
a controller configured to identify table IDs corresponding to the plurality of requests and configured to output the on signal to the corresponding table ID processors; and
a media access control (MAC) processor configured to parse the requests received by the server, transfer the parsed tasks to the controller, and output, to the one or more clients, the packets output from the table ID processors corresponding to the parsed requests.
